(19) United States
(12) Patent Application Publication
(10) Pub. No.: US 2019/0195375 A1
(43) Pub. Date: Jun. 27, 2019

(54) CARTRIDGE ASSEMBLY FOR A THERMALLY RESPONSIVE BY-PASS VALVE

(71) Applicant: Caltherm Corporation, Columbus, IN (US)

(72) Inventors: Kevin Oswald, Columbus, IN (US); Kurt Kushner, Columbus, IN (US); Morgan Greenlee, Hope, IN (US); Kyle Weidner, Columbus, IN (US); Jason Correll, Columbus, IN (US)

(73) Assignee: Caltherm Corporation, Columbus, IN (US)

(21) Appl. No.: 15/849,902

(22) Filed: Dec. 21, 2017

(51) Int. Cl. F16K 15/02; F01M 5/00

(52) U.S. Cl. CPC F16K 15/025; F01P 11/08; F01M 5/007

(57) ABSTRACT

A thermostatic cartridge assembly for a by-pass valve that regulates fluid flow between two different fluid circuits includes a casing defining a first fluid port and a second port; a thermostatic body having a piston movable along a central axis of the thermostatic body in response to heating and expansion of the thermally responsive material; a cap joined to a second end of the casing; a biasing member urging an end of the piston against a roof of the casing; and a sleeve carried by the thermostatic body, the sleeve having a circumferential side wall and a ceiling that seat against surfaces of the casing to block the first fluid port when the thermally responsive material is at a first temperature, the circumferential side wall blocking the second fluid port when the thermally responsive material is at a second temperature greater than the first temperature.

### CROSS-REFERENCE TO RELATED APPLICATIONS

Not Applicable.

### FIELD OF THE DISCLOSURE

This disclosure relates to valves having a thermally responsive element for circulating a fluid through a heat exchanger and/or a by-pass circuit, as needed, depending on the temperature of the fluid.

### BACKGROUND OF THE DISCLOSURE

Thermally responsive by-pass valves are often employed in vehicle coolant systems, engine lubricant systems and transmission fluid systems to by-pass heat exchangers until these fluids have heated up to normal operating temperatures. Such valves typically have a thermostatic element that is biased, such as by a spring, to position a valve member so that a first port is blocked and a second port is open while the fluid is at a temperature below the normal operating temperature to prevent the fluid from passing through the heat exchanger (i.e., allowing the fluid to by-pass the heat exchanger). As the fluid heats up (e.g., in the engine or transmission), heat from the fluid is transferred to the thermostatic element causing a thermally responsive material contained in the thermostatic element to expand and urge a piston to move outwardly from the thermostatic element and cause the valve member to move to a different position in which the first port is at least partially unblocked and the second port is partially blocked to allow fluid to be cooled as it passes through the heat exchanger.

Numerous designs have been developed for thermally responsive by-pass valves. However, there remains a need for an improved thermally responsive by-pass valve that facilitates servicing and installation of the valve, i.e., a valve construction that reduces the time and effort associated with installing the valve in a vehicle and replacing internal valve components.

### SUMMARY OF THE DISCLOSURE

Disclosed is a thermostatic cartridge assembly for a by-pass valve that regulates flow between two fluid circuits, and a by-pass valve employing the disclosed cartridge.

The cartridge includes a thermostatic body or element containing a thermally responsive material and having a piston that movably extends from one end of the thermostatic element, a sleeve carried by the thermostatic element and having a side wall, and a biasing member. The thermostatic element, sleeve and biasing member are retained within a casing between a roof at a first end of the casing and a cap joined to a second end of the casing. The thermally responsive material expands with an increase in temperature as it changes states from solid to liquid. This expansion exerts pressure which is translated against a surface of the piston and overcomes a force of the biasing member urging an end of the piston against the roof of the casing. The casing defines a first fluid port at a first end of the casing and a second fluid port at a central portion of the casing. The fluid ports interact with the sleeve to restrict or permit fluid flow through the two different fluid circuits. The cartridge comprises all internal moving components of a valve assembly, and is configured to be releasably mountable within a valve housing, such as with external threads of the cap engaging internal threads of a valve housing or with a retaining ring or clip.

A valve in accordance with this disclosure includes a cartridge as described releasably retained within a valve housing having a fluid outlet, a first fluid inlet in fluid communication with the first port when the piston extends from the thermostatic element due to expansion of the thermally responsive material, and a second fluid inlet in fluid communication with the second port when the piston is not fully extended, such as when the fluid is at a temperature below the normal operating temperature.

### BRIEF DESCRIPTION OF THE DRAWINGS

FIG. 1 is an exploded assembly diagram of a cartridge for a thermally responsive by-pass valve.

FIGS. 2A-2C are cross-sectional views showing three alternative thermostatic elements that can be used in the cartridge shown in FIG. 1.

FIG. 3 is a cutaway perspective view of a thermally responsive by-pass valve using the cartridge of FIG. 1.

FIG. 4 is a cross-sectional view of the thermally responsive by-pass valve with the thermostatic element and other internal valve components positioned to block flow from a first valve inlet and allow flow of fluid from a second valve inlet.

FIG. 5 is a cross-sectional view of the thermally responsive by-pass valve with the thermostatic element and other internal valve components positioned to allow partial flow from the first inlet and partial flow from the second inlet.

FIG. 6 is a cross-sectional view of the thermally responsive by-pass valve with the thermostatic element and other internal valve components positioned to allow flow from the first valve inlet and block fluid flow from the second valve inlet.

FIG. 7 shows an alternate embodiment in which the cartridge is secured to the valve housing using a ring retainer and mating groove in the housing.

FIG. 8 is a bottom view of the embodiment shown in FIG. 7.

### DETAILED DESCRIPTION

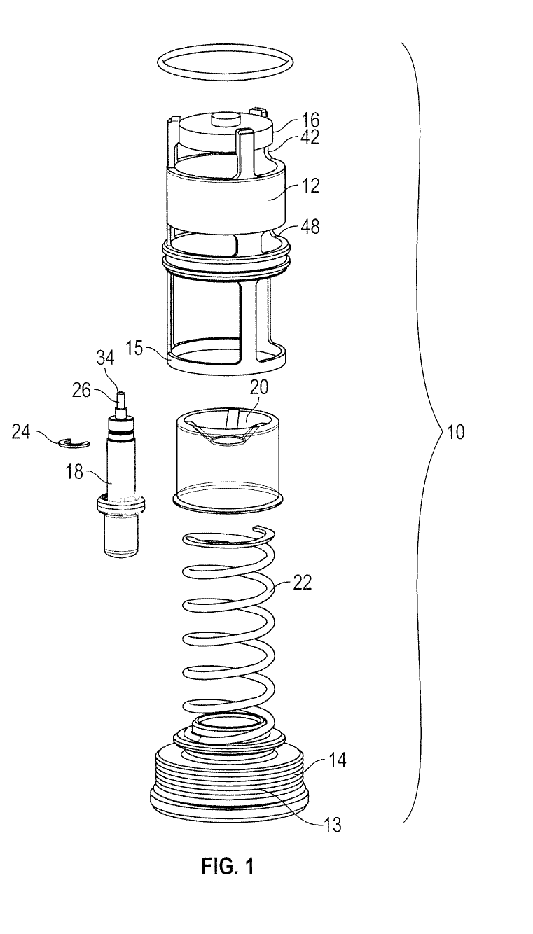

As shown in the exploded assembly diagram of FIG. 1, a cartridge 10 includes a casing 12 and a cap 14 having threads 13. Cap 14 is secured to an end 15 of casing 12. Contained within casing 12, between a roof 16 and cap 14 are a thermostatic element 18, a sleeve 20 carried by the thermostatic element, and a biasing member 22 (e.g., coil spring) compressed between cap 14 and sleeve 20. A retainer or clip 24 may be used to secure sleeve 20 on element 18.

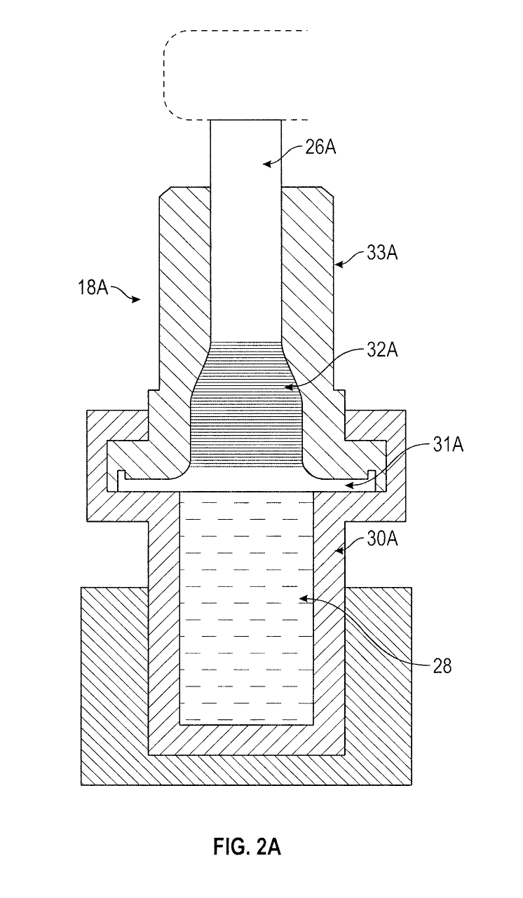

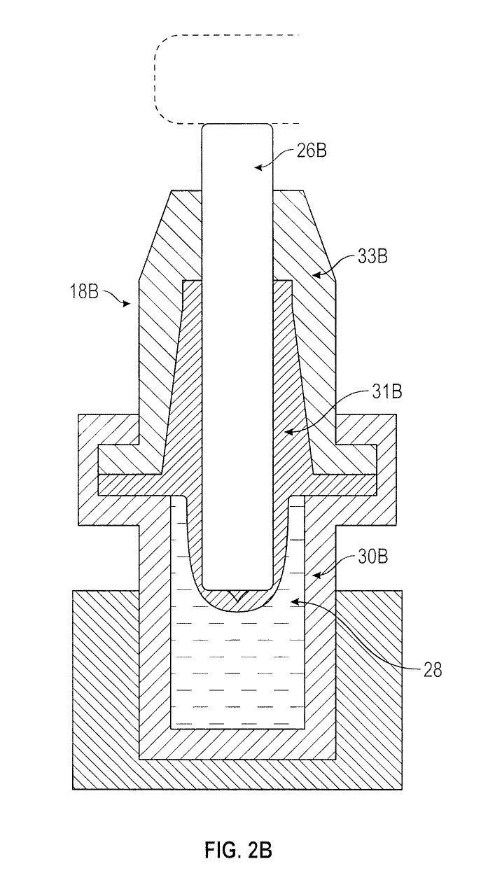

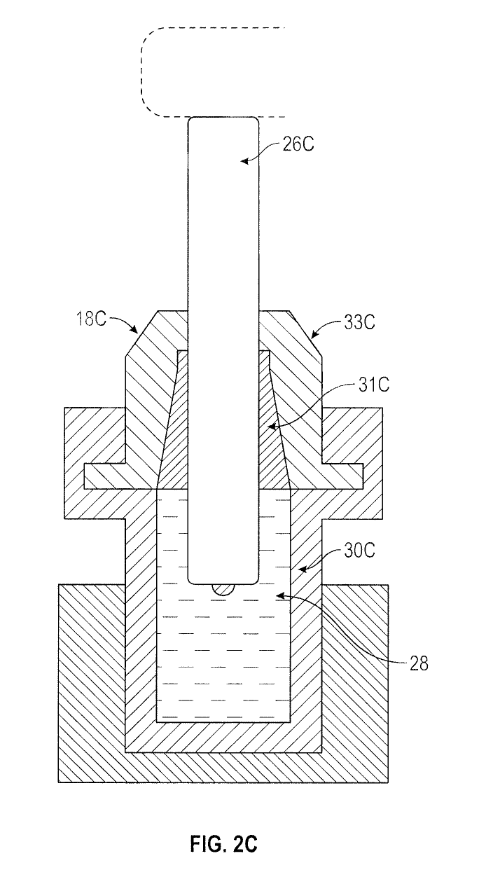

As shown in the cross-sectional view of FIG. 2A, thermostatic element 18A includes a piston 26A that is axially movable in response to a temperature change. Element 18A contains a thermally responsive material 28 held in a cup 30A. A diaphragm 31A seals thermally responsive material 28 in cup 30A and transmit expansion of material 28 to a plug 32A that amplifies the expansion causing piston 26A to move linearly (upwardly) along guide 33A, allowing piston 26 to transmit forces to move sleeve 20 within a valve 37.

FIG. 2B shows an alternative thermostatic element 18B having a piston 26B that is axially movable in guide 33B in response to a temperature change. A thermally responsive material 28 is held in a cup 30B. A diaphragm 31B seals expansion material 28 in cup 30B and transmits expansion to piston 26B to move sleeve 20 within valve 37.

FIG. 2C shows another alternative thermostatic element 18C having a piston 26C that is axially movable in guide 33C in response to a temperature change. Thermally responsive material 28, held in cup 30C expands when heated moving piston 26C upwardly within seal 31C, which retains material 28 in cup 30C.

Thermostatic elements 18A-18C are illustrative of a variety of devices that can be used to transform heat energy into mechanical energy via movement of a piston using thermal expansion materials 28. Expansion is typically a result of a change in state from (e.g., solid to liquid).

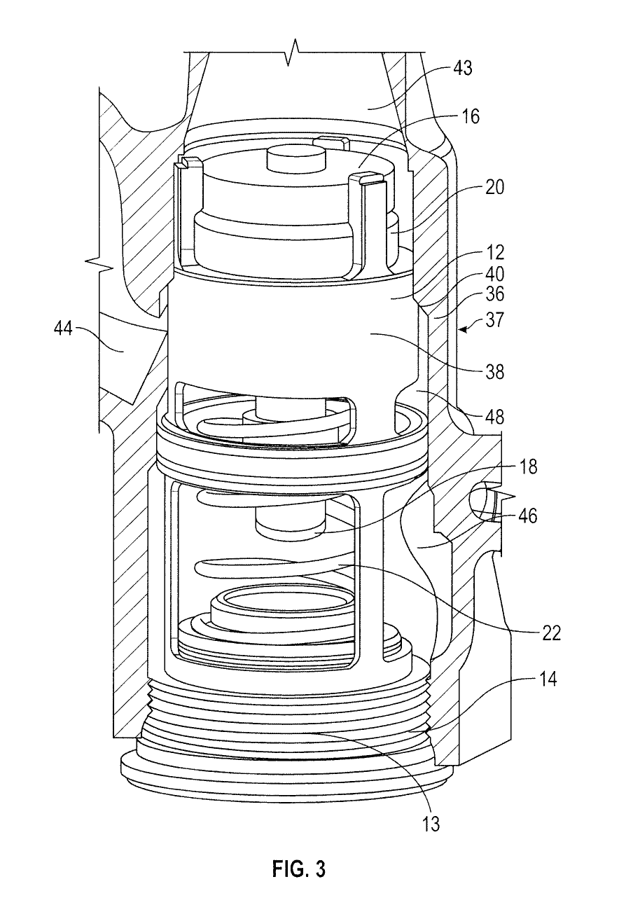

As shown in the cutaway perspective view of FIG. 3, cartridge 10 is configured to fit within a valve housing 36 of a by-pass valve 37. By-pass valve 37 is a section of the engine manifold housing 36 containing cartridge 10. Illustrated casing 12 has an overall or generally cylindrical shape with a wall portion 38 having a surface that faces radially outwardly from a central axis of the cartridge which abuts an inwardly facing surface 40 of housing 36. Cartridge 10 also defines a first port 42 (see FIG. 1), which is blocked by sleeve 20 in FIG. 3. Housing 36 defines a first fluid inlet 43 (such as from a heat exchanger or radiator), a second fluid inlet 44 (such as from an engine), and a fluid outlet 46 (such as to the engine).

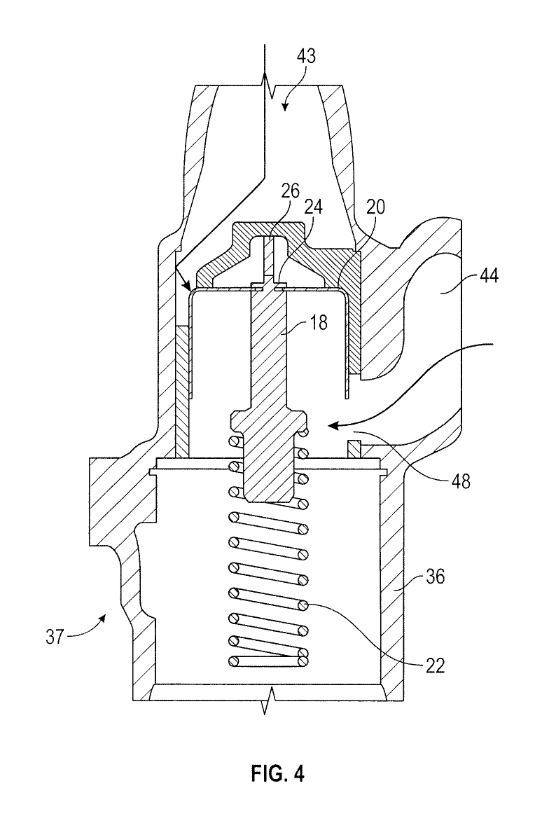

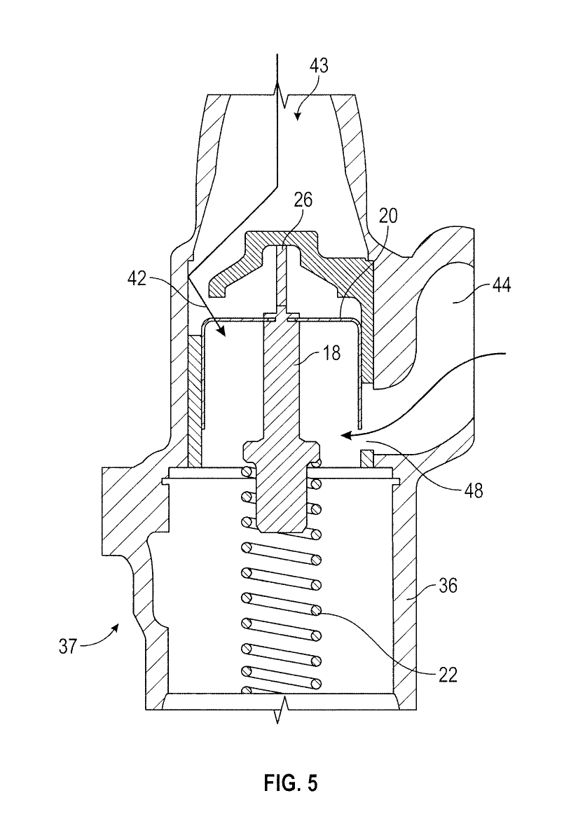

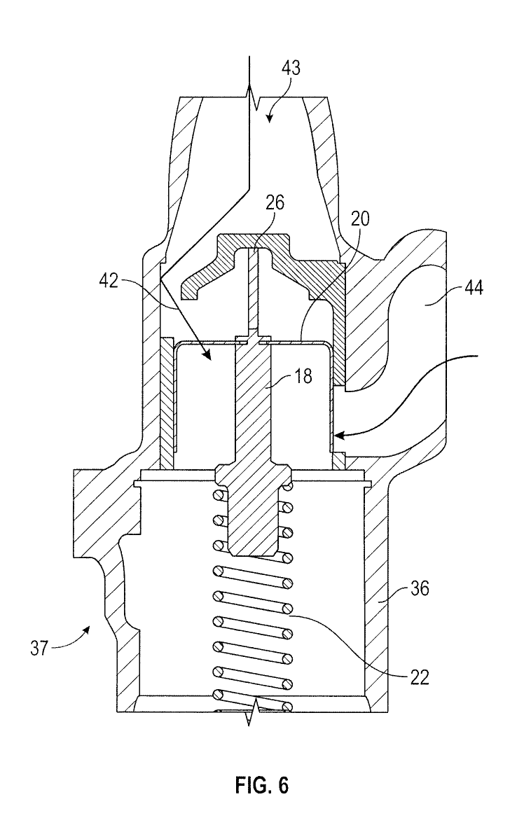

FIGS. 3 and 4 show the thermostatic element 18 and carried sleeve 20 in a first position in which port 42 is blocked by sleeve 20 urged by spring 22 against roof 16 of casing 12 and against seating surface of casing 12 to limit or prevent flow of fluid into valve 37 and out of fluid outlet 46. In an engine lubrication system or engine coolant system, the valve position shown in FIGS. 3 and 4 can be used for by-passing a cooling heat exchanger (e.g., radiator), allowing fluid to circulate directly back to the engine until it reaches a threshold temperature that causes sufficient expansion of thermally responsive material 28 to cause thermostatic element 18 and carried sleeve 20 to be urged downwardly with sufficient force to overcome the force of spring 22. FIG. 5 shows element 18 and sleeve 20 in a partially open position in which port 42 is unblocked allowing fluid to flow through port 42 and into valve 37. In the partially open position shown in FIG. 5, a second port 48 defined in casing 12 is partially blocked by the sidewall of sleeve 20, limiting fluid flow directly from the engine. This provides a mixture of fluid from the cooler and fluid directly form the engine to flow from outlet 46 to the engine. As the fluid continues to heat, further expansion of the thermally responsive material 28 in thermostatic element 18 causes element 18 and carried sleeve 20 to move toward cap 14 against compression spring 22 into a position (shown in FIG. 6), in which sleeve 20 blocks port 48 and fully opens port 42, such that flow through the by-pass is restricted or limited and most or all of the fluid (e.g., engine coolant, lubricating oil, or transmission fluid) is circulated through a heat exchanger (e.g., cooler or radiator).

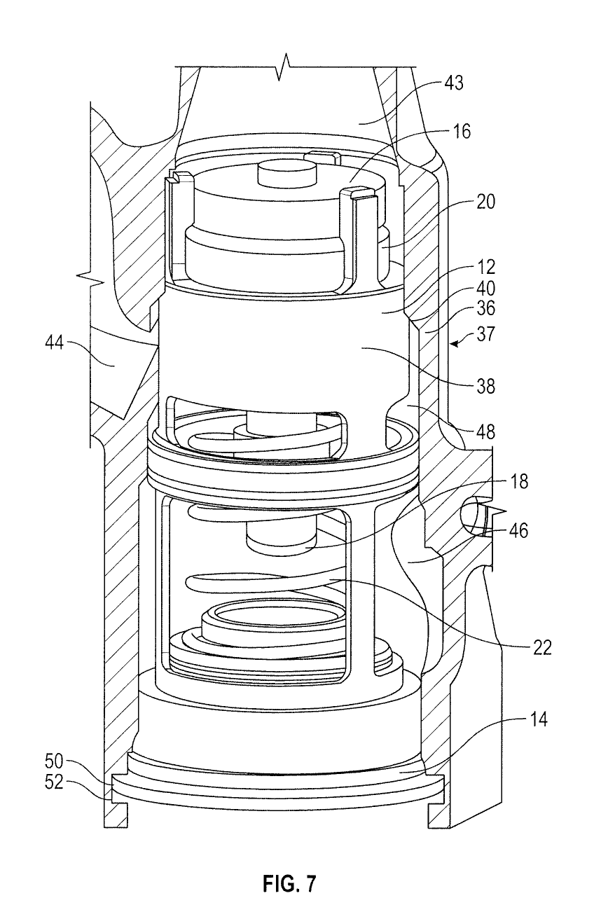

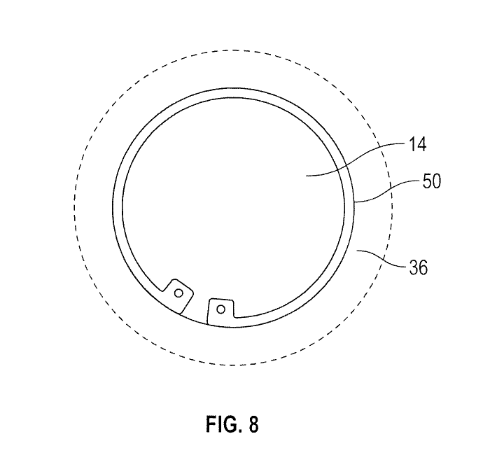

In the illustrated embodiment (FIG. 3), cap 14 is threadingly secured to the body of valve housing 36. Alternatively, cap 14 can be made to fit within housing 36 and be held in place with a snap or retaining ring 50 (FIGS. 7 and 8). A mating groove 52 can be present within the housing.

As the circulated fluid begins to cool (such as during engine idle or after the engine is turned off), the thermally responsive material cools and contracts allowing spring 22 to urge sleeve 20 toward roof 16 to close port 42 and open port 48.

Such by-pass valves including known by-pass valves, improve fuel efficiency by allowing fluids to by-pass cooling heat exchangers and heat up more quickly until the engine and fluids have reached a fuel efficient operating temperature. Such by-pass valves are also desirable to allow fluids (especially lubricants) to achieve a lower viscosity at the higher temperature, thereby reducing wear on pumps due to high back pressure through the heat exchanger when the fluid is at a low temperature.

The by-pass valve disclosed herein has the advantage of allowing the moving or operable components, namely the thermostatic element, ports, seating surfaces and biasing member, to be present in a cartridge assembly that can be easily installed or removed, such as for servicing or replacement of valve components. The cartridge can also be removed during brazing or welding operations on the valve housing 36 to avoid damage to the internal valve component, such as during installation.

It is also believed that the cartridge structure reduces the number of components required for a thermostatic by-pass valve. In particular, by having the outwardly protruding end 34 of the piston 26 engage a roof 16 of casing 12, the need for a return spring, poppet valve and spring retainer featured in conventional thermostatic by-pass valves is eliminated.

Accordingly, it is to be understood that the above description is intended to be illustrative and not restrictive. Many embodiments and applications other than the examples provided would be apparent upon reading the above description. The scope of the invention should be determined with reference to the appended claims along with the full scope of equivalents to which such claims are entitled. It is anticipated and intended that future developments will occur, and that the disclosed systems and methods will be incorporated into such future embodiments. In summary, it should be understood that the invention is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc., should be read to recite one or more of the indicated elements unless a claim recites an explicit limitation to the contrary.

What is claimed is:

1. A thermostatic cartridge assembly for a by-pass valve, comprising:
a casing defining a first fluid port and a second fluid port;
a thermostatic element containing a thermally responsive material, and having a piston movable in response to heating and expansion of the thermally responsive material;
a cap joined to the casing;
a biasing member compressed between the cap and the thermostatic element, the biasing member urging an end of the piston against a roof of the casing;
a sleeve carried by the thermostatic element, the sleeve having a side wall that seats against first surfaces of the casing to block fluid flow through the first port when the thermally responsive material is at a first temperature, and that seats against second surfaces of the casing to block fluid flow through the second port when the thermally responsive material is at a second temperature greater than the first temperature.

2. The cartridge of claim 1, wherein the thermostatic element, biasing member and sleeve are retained within the casing between the cap and the roof of the casing.

3. The cartridge of claim 1, wherein the biasing member is a coil spring.

4. The cartridge of claim 1, wherein the cap is externally threaded.

5. The cartridge of claim 1, wherein a retainer secures the sleeve to the thermostatic element.

6. A by-pass valve comprising:
a valve housing defining a first fluid inlet, a second fluid inlet, a fluid outlet and an opening for receiving a cartridge assembly; and
a cartridge assembly including a casing defining a first fluid port and a second fluid port; a thermostatic element containing a thermally responsive material, and having a piston movable in response to heating and expansion of the thermally responsive material; a cap joined to the casing; a biasing member compressed between the cap and the thermostatic element, the biasing member urging an end of the piston against a roof of the casing; a sleeve carried by the thermostatic element, the sleeve having a side wall that seats against first surfaces of the casing to block fluid flow through the first port when the thermally responsive material is at a first temperature, and that seats against second surfaces of the casing to block fluid flow through the second port when the thermally responsive material is at a second temperature greater than the first temperature.

7. The valve of claim 6, wherein the thermostatic element, biasing member and sleeve are retained within the casing between the cap and the roof of the casing.

8. The valve of claim 6, wherein the biasing member is a coil spring.

9. The valve of claim 6, wherein the cap is externally threaded.

10. The valve of claim 6, wherein a retainer secures the sleeve to the thermostatic element.
